(19) United States
(12) Patent Application Publication
(10) Pub. No.: US 2014/0168800 A1
(43) Pub. Date: Jun. 19, 2014

(54) LENS MODULE

(71) Applicant: HONG HAI PRECISION INDUSTRY CO., LTD., New Taipei (TW)

(72) Inventor: RONG-JHE CHEN, New Taipei (TW)

(73) Assignee: HON HAI PRECISION INDUSTRY CO., LTD., New Taipei (TW)

(21) Appl. No.: 13/889,371

(22) Filed: May 8, 2013

(30) Foreign Application Priority Data
Dec. 19, 2012 (TW) 101148290

(51) Int. Cl. G02B 7/02

(52) U.S. Cl. CPC G02B 7/02
USPC 359/827

(57) ABSTRACT

A lens module includes a base lens and an optical device. The base lens includes a lens barrel, the lens barrel includes a flat end surface, a circumferential surface, and a dispensing groove distributed in the end surface, a fixing glue to be dispensed in the dispensing groove. The optical device includes a flat light output surface. The flat light output surface makes close and tight contact with the end surface to avoid tilt or dis-alignment in production, the fixing glue connects the lens barrel and the optical device.

### BACKGROUND

1. Technical Field

The present disclosure relates to an optical field, and particularly to a lens module.

2. Description of Related Art

An additional optical device is integrated into a camera module for achieving farther optical functions, such as auto focus or optical image stabilization. The additional optical devices are active and having a complicated design in general. In assembly, these optical devices can be fixed by glue on the lens barrel. Referring to FIG. 1, if the volume of glue 10 is inconsistent at different positions when assembling the devices to the lens barrel, tilt or dis-alignment between the optical device and the lens barrel will occur and affect the image quality. Therefore, a new lens module is required to overcome the above issues.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a cross sectional view of a conventional lens module.

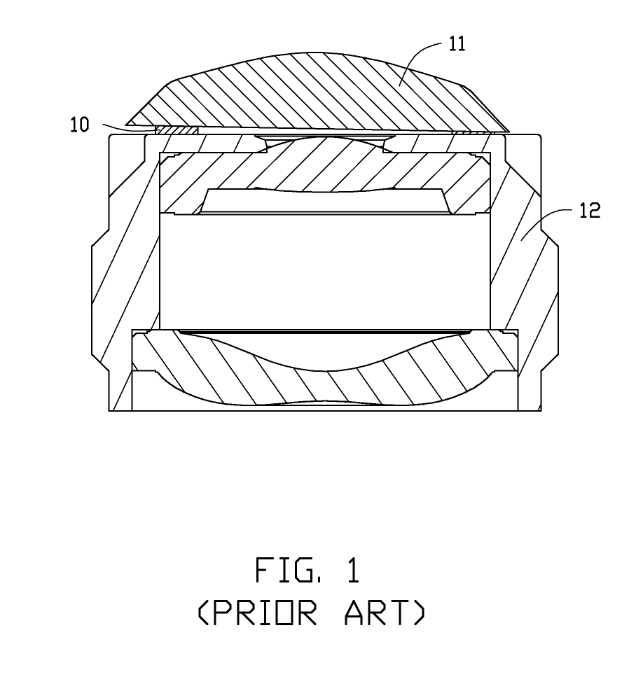

FIG. 2 is an exploded view of a lens module, in accordance with an exemplary embodiment.

FIG. 3 is an exploded view of a lens module of FIG. 2 from another angle.

FIG. 4 is a perspective view of a lens module of FIG. 2.

FIG. 5 is an exploded view of second embodiment of a lens module.

FIG. 6 is an exploded view of third embodiment of a lens module.

### DETAILED DESCRIPTION

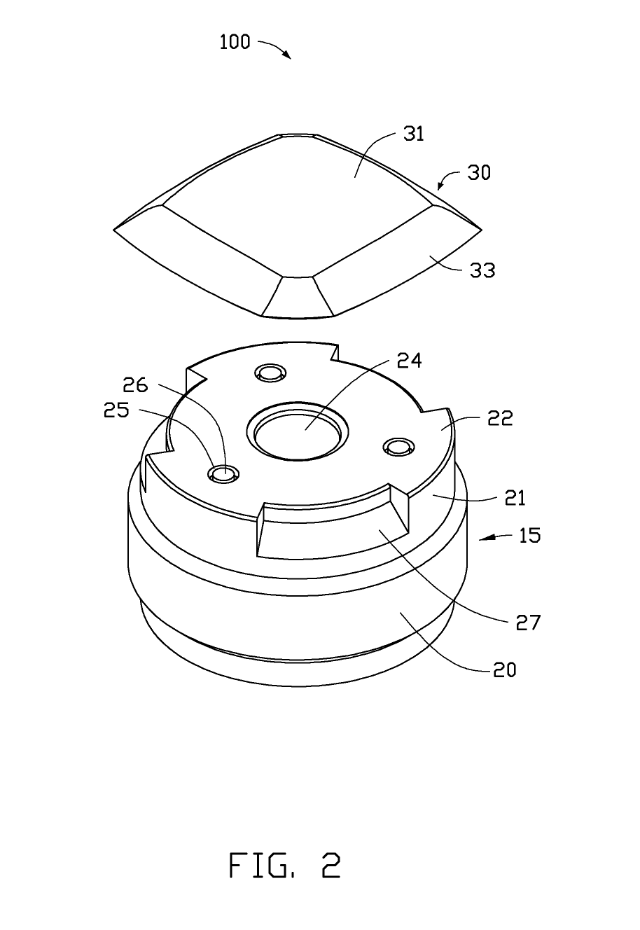

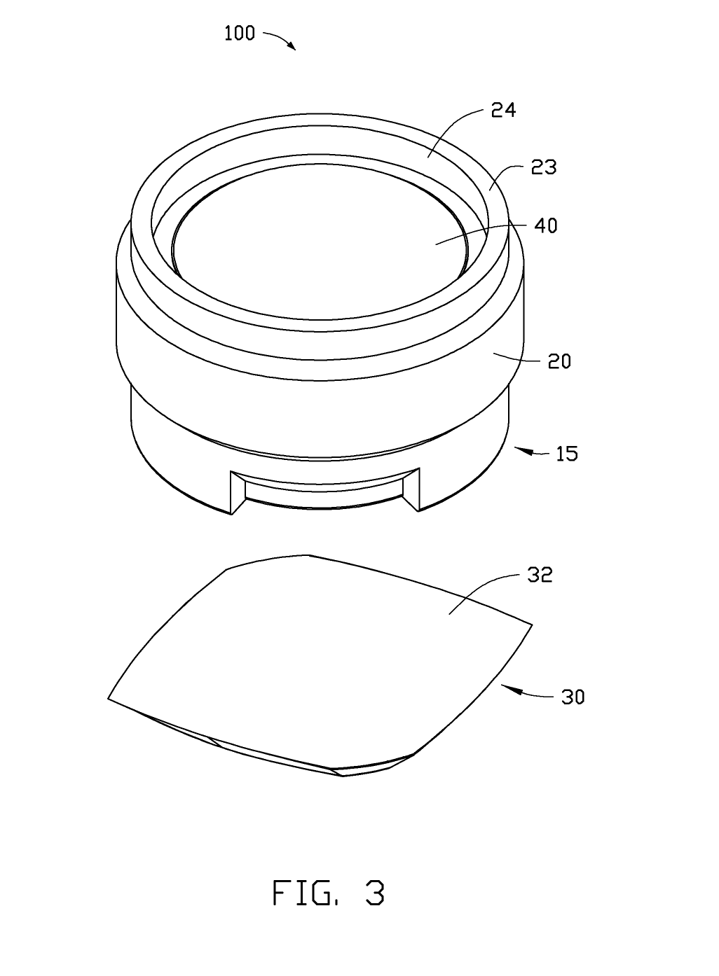

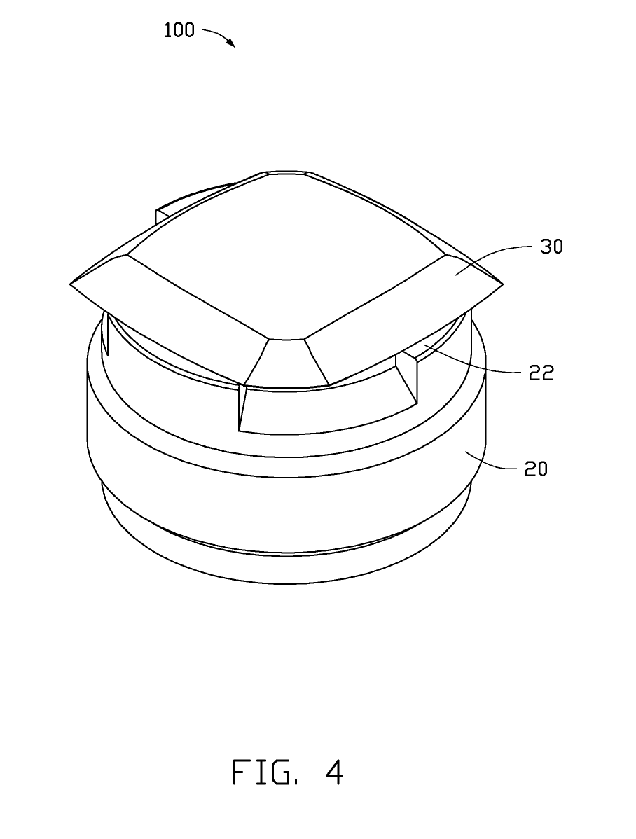

Embodiments will now be described in detail below with reference to the drawings. Referring to FIGS. 2-4, a lens module 100 according an exemplary embodiment is shown. The lens module 100 includes a base lens 15 and an optical device 30. The base lens 15 includes a lens barrel 20 and few lenses fixed inside the lens barrel 20, such as a lens 40, a filter (not shown), and a spacer ring (not shown). In the present embodiment, the lens barrel 20 showing a stepped cylindrical shape. In alternative embodiments, the lens barrel 20 may be another shape, such as angular. The lens barrel 20 includes a circumferential surface 21 and end surfaces 22, 23 on both sides of the circumferential surface 21. In the present embodiment, the circumferential surface 21 showing a stepped shape. The end surfaces 22, 23 are flat. Between the end surface 22 and the end surface 23 a light aperture 24 is defined, passing through the lens barrel 20. The light aperture 24 is a stepped circular through hole, diameter of the light aperture 24 at the end surface 22 is less than the diameter at the end surface 23. The light aperture is configured for receiving and fixing the lens 40.

The end surface 22 surrounding the light aperture 24 defines a plurality of dispensing grooves 25. In the present embodiment, each dispensing groove 25 is a circular blind hole, these are uniformly distributed in the end surface 22. The dispensing groove 25 is configured for dispensing fixing glue 26. Between the end surface 22 and the circumferential surface 21 a plurality of peripheral notches 27 are defined. Each notch 27 is curved, extending around the circumferential surface 21, and being uniformly distributed around the light aperture 24. The notches 27 are configured to facilitate placement of the base lens 15 into other parts, such as a holder (not shown).

The optical device 30 is configured for performing certain functions in lens module 100, such as auto focus function or optical image stabilization. The optical device 30 has a complex structure (not shown). In this embodiment, the optical device 30 has a square plate shape; however, in alternative embodiments, the shape of optical device 30 may be other shapes. The optical device 30 includes a light incident surface 31, and a light output surface 32 opposite to the light incident surface 31. The light incident surface 31 is gently curved, the light output surface 32 is substantially flat. The optical device 30 defines a plurality of connecting surfaces 33 connected between the optical incident surface 31 and the optical output surface 32.

In assembly, the optical device 30 is placed above the end surface 22 of the lens barrel 20, the light output surface 32 in close contact with the end surface 22. The fixing glue 26 is dispensed inside the dispensing groove 25, connecting the optical device 30 and the lens barrel 20. In this way, the optical device 30 is fixed on the lens barrel 20. The end surface 22 having the dispensing groove 25 thereon is shaped and configured for dispensing the fixing glue 26, therefore the light output surface 32 and the end surface 22 make tight and complete contact, resulting in a substantial reduction of any tilt or dis-alignment between the optical device 30 and the lens barrel 20.

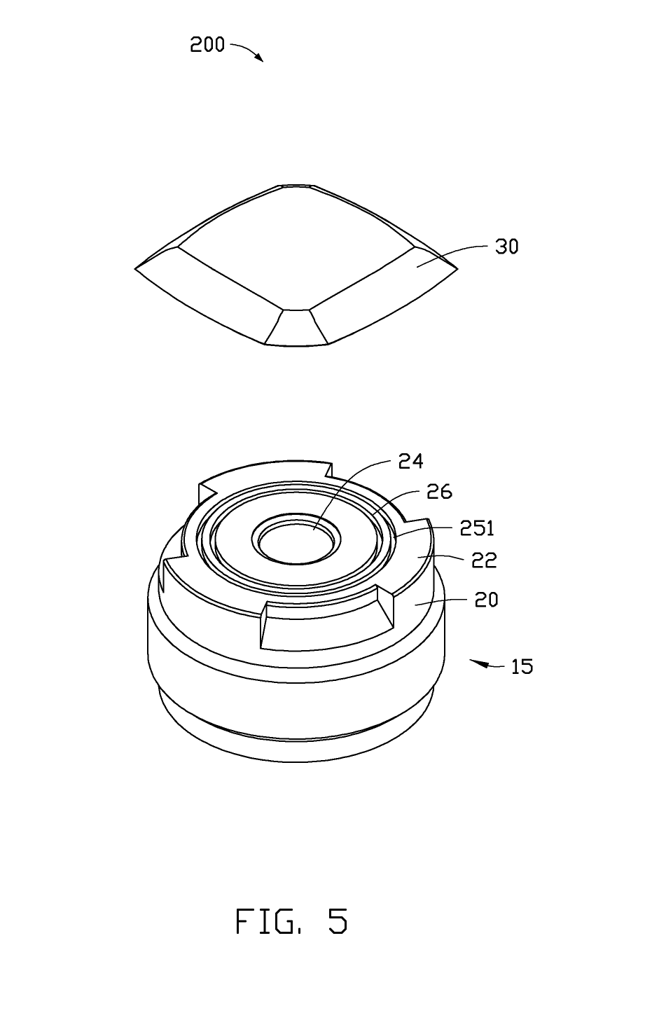

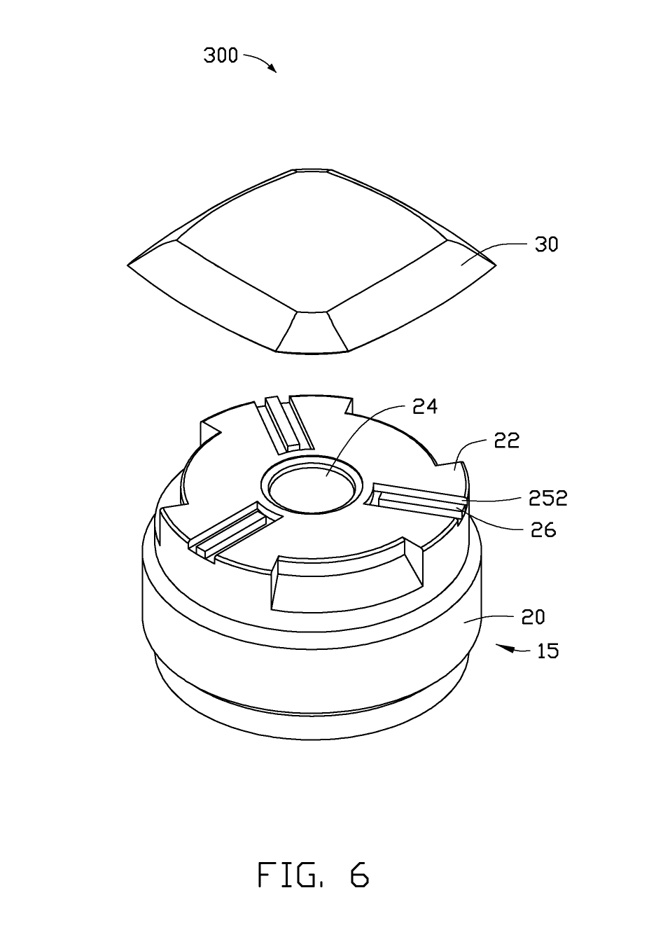

Referring to FIG. 5, a second embodiment is disclosed, the second embodiment includes a lens module 200. The lens module 200 is similar to the lens module 100, the difference being that dispensing groove 251 on the end surface 22 of the lens barrel 20 of lens module 200 is in the shape of a ring, surrounding the light aperture 24 of the lens barrel 20. Referring to FIG. 6, a third embodiment is disclosed. The third embodiment includes a lens module 300, the lens module 300 is similar to the lens module 100, the difference being that there is a plurality of dispensing grooves 252 on the end surface 22 of the lens barrel 20 of the lens module 300 which are radially distributed from the center light aperture 24.

Although the present disclosure has been specifically described on the basis of these exemplary embodiments, the disclosure is not to be construed as being limited thereto. Various changes or modifications may be made to the embodiments without departing from the scope and spirit of the disclosure.

What is claimed is:

1. A lens module, comprising:
a base lens comprising a lens barrel, and an optical device;
wherein the lens barrel comprises a circumferential surface and end surfaces, the end surfaces are flat;
a dispensing groove distributing in the end surfaces; and
a fixing glue dispensed inside the dispensing groove;
wherein the optical device comprises a light output surface, the light output surface is flat; the light output surface closely contacting with the end surface, the fixing glue connecting the lens barrel and the optical device.

2. The lens module as claimed in claim 1, wherein the lens barrel comprises a light aperture between the end surfaces, and passing through the lens barrel.

3. The lens module as claimed in claim 2, wherein the light aperture comprises a lens.

4. The lens module as claimed in claim 1, wherein each of the dispensing grooves is a circular blind hole, and uniformly distributed in the end surface.

5. The lens module as claimed in claim 1, wherein the dispensing groove on the end surface of the lens barrel is in a shape of a ring.

6. The lens module as claimed in claim 1, wherein a plurality of dispensing grooves on the end surface of the lens barrel which radially distributed from the center light aperture.

7. The lens module as claimed in claim 1, wherein between the end surface and the circumferential surface define a plurality of peripheral notches.

8. The lens module as claimed in claim 1, wherein the optical device comprises a light incident surface, and a light output surface opposite to the light incident surface.
